(19) United States
(12) Patent Application Publication
(10) Pub. No.: US 2025/0166601 A1
(43) Pub. Date: May 22, 2025

(54) SYSTEMS AND METHODS FOR ADAPTIVE TEXT TO SPEECH FOR DIVERSE STYLES

(71) Applicant: Datum Point Labs Inc., Jackson, WY (US)

(72) Inventors: Jeongki Min, Seoul (KR); Hanseok Ko, Seoul (KR); Bonhwa Ku, Seoul (KR)

(21) Appl. No.: 18/952,738

(22) Filed: Nov. 19, 2024

Related U.S. Application Data
(60) Provisional application No. 63/602,090, filed on Nov. 22, 2023.

(51) Int. Cl. G10L 13/027

(52) U.S. Cl. CPC G10L 13/027

(57) ABSTRACT

Embodiments described herein provide adaptive text to speech (TTS) methods for generating voices in diverse styles is built on a pretrained TTS model and an age/gender/emotion recognition model and conditional LoRa (Low-Rank Adaptation of Large Language Models) module that is a style adaptation module. The style adaptation module generates style vectors, where a style consists of a combination of acoustic properties such as tone, speaking rate, accent, etc. These methods allow for generation of diverse voice styles, including seen and unseen styles (i.e., styles not used in the training dataset).

### TECHNICAL FIELD

The embodiments relate generally to systems and methods for text to speech generation.

### BACKGROUND

In machine learning, text to speech (TTS) models may generate audio speech for a given text input. Existing TTS models produce speech with one fixed style voice, and to generate new voices, the TTS model needs to be trained with a large amount of data for the specific voice (e.g., multiple hours of audio). This process is a costly limitation in TTS for diverse styles of voices. Therefore, there is a need for improved systems and methods for text to speech generation for diverse styles.

### BRIEF DESCRIPTION OF THE DRAWINGS

FIG. 1A illustrates an exemplary framework for text to speech generation, according to some embodiments.

FIG. 1B is a simplified diagram of a style module, according to some embodiments.

FIG. 1C is a simplified diagram of a conditional LoRa, according to some embodiments.

FIG. 1D is a simplified diagram of a decoder, according to some embodiments.

FIG. 2 is a simplified diagram illustrating a computing device implementing the framework described in FIGS. 1A-1D, according to some embodiments.

FIG. 3 is a simplified block diagram of a networked system suitable for implementing the framework described in FIGS. 1A-1D and other embodiments described herein.

### DETAILED DESCRIPTION

In machine learning, text to speech (TTS) models may generate audio speech for a given text input. Existing TTS models produce speech with one fixed style voice, and to generate new voices, the TTS model needs to be trained with a large amount of data for the specific voice (e.g., multiple hours of audio). This process is a costly limitation in TTS for diverse styles of voices. In view of the need for improved systems and methods for text to speech generation for diverse styles, embodiments described herein overcome these limitations by use of adaptive TTS with a generalized style adaptation module to generate new voices with few-data learning. In some embodiments, diverse styles of voices are generated through an adaptation module using age, gender and emotion recognition models.

Embodiments described herein include an adaptive text to speech (TTS) technique that can generate voices of various styles. In reality, people can express more diverse styles in their utterances than only a single style. Diverse styles include utterances with multiple speakers and multiple emotions, and include age, gender, emotion and other information. In some embodiments, the adaptive TTS method for generating voices in diverse styles is built on a pretrained TTS model and an age/gender/emotion recognition model and conditional LoRa (Low-Rank Adaptation of Large Language Models) module that is a style adaptation module. The style adaptation module generates style vectors, where a style consists of a combination of acoustic properties such as tone, speaking rate, accent, etc. These methods allow for generation of diverse voice styles, including seen and unseen styles (i.e., styles not used in the training dataset).

Embodiments described herein provide a number of benefits. Other TTS methods are applied using a single encoder module with style adaption for seen and unseen generations. Embodiments described herein enable seen and unseen speech generations for people of genders and old and young, including diverse styles. For this purpose, the age/gender/emotion recognition models are used as an encoder module to generate more diverse styles. Further, stable learning for adaptation of style may use conditional LoRa (Low-Rank Adaptation of Large Language Models) modules to learn changes of style, leading to efficient learning of adaptation. Methods described herein obviate the need for large datasets of audio data for each specific style desired, and obviates the need for a separately trained full model for each style, thereby reducing the memory and/or computation requirements for performing text to speech with various styles.

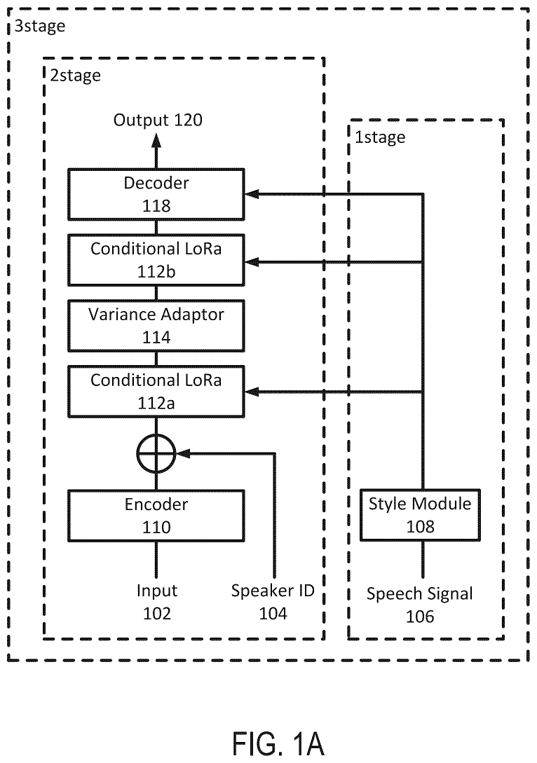

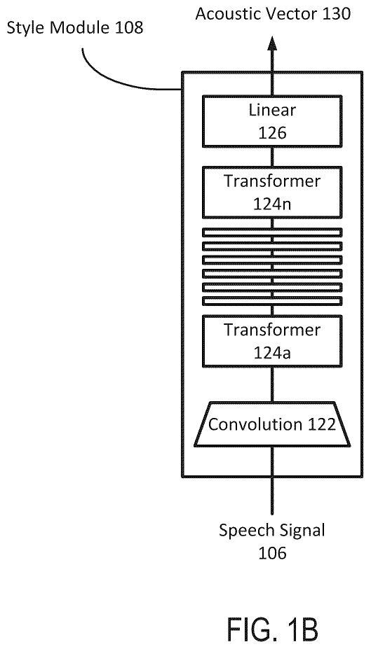

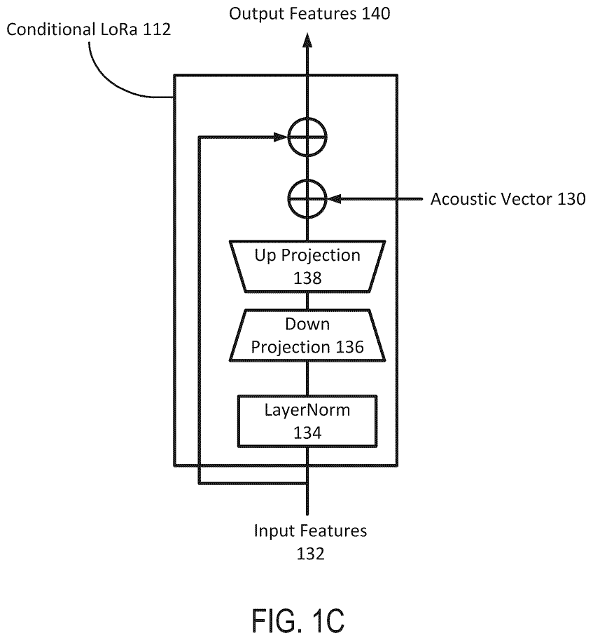

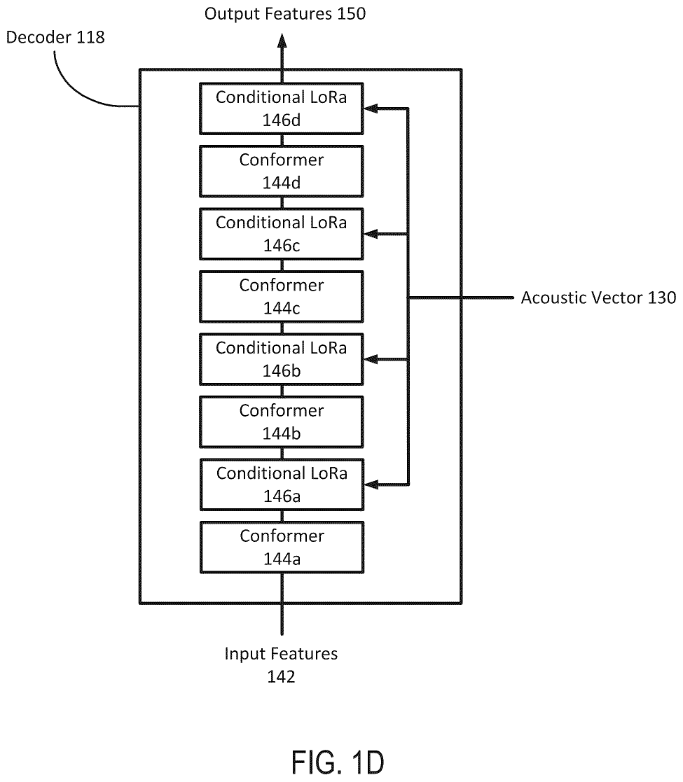

FIG. 1A illustrates an exemplary framework for text to speech generation, according to some embodiments. For style adaptation, the framework may include three stages as illustrated in FIG. 1A.

In the first stage, a style module 108 generates a style vector (e.g., acoustic vector 130 in FIGS. 1B-1D) based on a speech signal 106, which is combined with acoustic properties. The style vector may be trained to enable emotion recognition of input speech by fine-tuning a pretrained audio to vector model.

In the second stage, a pretrained TTS model receives speaker embedding information as a condition and is trained. The pretrained TTS model may include an encoder 110 which encodes input 102 (e.g., text input). The encoded input may be summed with a speaker ID 104 and passed to the first conditional LoRa 112a. The output of conditional LoRa 112a may be input to a variance adaptor 114, which passes its output to another conditional LoRa 112b. The output of conditional LoRa 112b may be decoded by a decoder 118 to provide output 120, which is generated speech of the selected style.

In the third stage, in order to combine the two pre-trained models into one, a conditional LoRA module 112 (e.g., Conditional LoRa 112a-112b) is added to the existing model structure and trained. Applying a conditional LoRa to speech synthesis enables efficient parameter learning and change through adaptation. Conditional LoRa is designed to allow a style vector (e.g., acoustic vector 130) to affect the learning of the decoder 118 by adding LayerNorm, conditional summation, and/or residual structure to the existing LoRa structure.

FIG. 1B is a simplified diagram of a style module 108 (e.g., the style module 108 of FIG. 1A), according to some embodiments. In some embodiments, the audio to vector model consists of 12 transformer blocks (e.g., transformer blocks 124), a pooling layer (e.g., convolution 122), and a projection layer (e.g., linear layer 126). For example, the speech signal 106 may be input to convolution 122. The output of convolution 122 may be passed through a series of transformer blocks 124a-124n. In some embodiments, there are 12 transformers 124 in style module 108. The output of the final transformer 124 (e.g., transformer 124n) is input to an output linear layer 126. The output of linear layer 126 is an acoustic vector 130, which may be used as an input to the conditional LoRa 112, conditional LoRa 146, and/or decoder 118 as described in FIGS. 1A, 1C, and 1D.

FIG. 1C is a simplified diagram of a conditional LoRa 112 (e.g., the conditional LoRa 112 of FIG. 1A or conditional LoRa 146 of FIG. 1D), according to some embodiments. The conditional LoRa 112 may take input features 132, and input them to a LayerNorm layer 134. The output of the layer Norm layer 134 is input to a down projection 136. The output of down projection 136 may be input to up projection 138. The output of up projection 138 may be summed with acoustic vector 130. The output of this sum may be summed with input features 132 to provide output features 140.

FIG. 1D is a simplified diagram of a decoder 118 (e.g., decoder 118 of FIG. 1A), according to some embodiments. In some embodiments, decoder 118 includes multiple pairs of conformer 144 and conditional LoRa 146 layers. For example, input features 142 may be sequentially altered bay a conformer 144a, conditional LoRa 146a, conformer 144b, conditional LoRa 146b, conformer 144c, conditional LoRa 146c, conformer 144d, and conditional LoRa 146d to provide output features 150. The conditional LoRa 146 layers may be conditioned by acoustic vector 130.

In some embodiments, performance may be further enhanced by applying pitch optimization with conditional LoRa for training predictor of pitch predictor in variance adaptor. The application of pitch optimization may lead to improvement in similarity scores through finding optimal pitch values of pre-trained variance pitch values of TTS and pitch related style features of style vector from style module 108. Further, in some embodiments to generate voice of unseen styles, style module 108 may be replaced with a predictor module which predicts mean and variance of a style vector, such as speaker latent space. The style vector of the adaptation module based on statistical approach may provide better flexibility to seen and unseen style situation than recognition models.

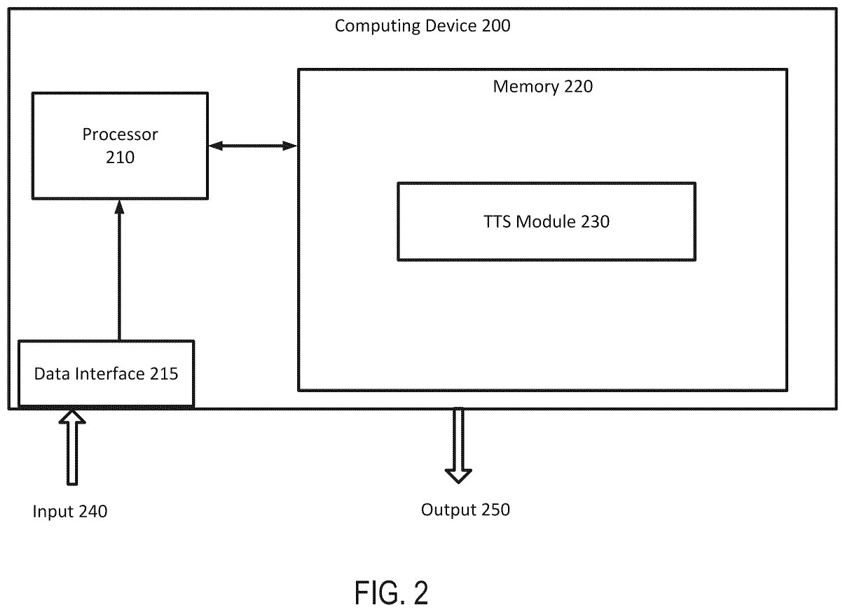

FIG. 2 is a simplified diagram illustrating a computing device 200 implementing the framework described in FIGS. 1A-1D, according to some embodiments. As shown in FIG. 2, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for TTS module 230 that may be used to implement and/or emulate the systems and models, and/or to implement any of the methods described further herein. TTS module 230 may receive input 240 such as Audio input, text input, and/or style selection input and generate an output 250 which may be a generated speech audio.

The data interface 215 may comprise a communication interface, a user interface (such as a voice input interface, a graphical user interface, and/or the like). For example, the computing device 200 may receive the input 240 from a networked device via a communication interface. Or the computing device 200 may receive the input 240, such as images, from a user via the user interface.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

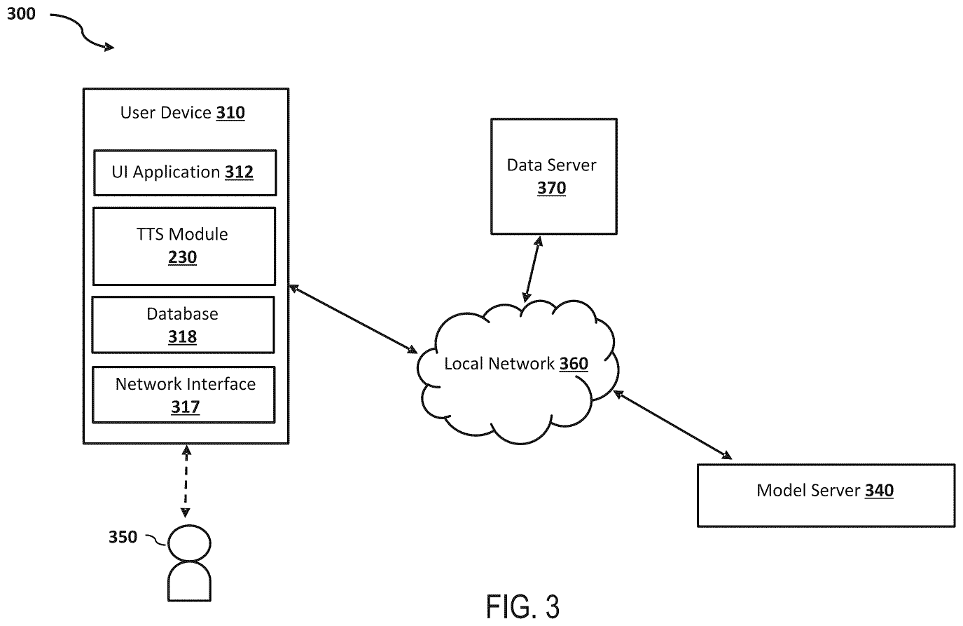

FIG. 3 is a simplified block diagram of a networked system 300 suitable for implementing the framework described in FIGS. 1A-1D and other embodiments described herein. In one embodiment, system 300 includes the user device 310 (e.g., computing device 200) which may be operated by user 350, data server 370, model server 340, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

User device 310, data server 370, and model server 340 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over local network 360.

In some embodiments, all or a subset of the actions described herein may be performed solely by user device 310. In some embodiments, all or a subset of the actions described herein may be performed in a distributed fashion by various network devices, for example as described herein.

User device 310 may be implemented as a communication device that may utilize appropriate hardware and software configured for wired and/or wireless communication with data server 370 and/or the model server 340. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312, and TTS module 230, which may correspond to executable processes, procedures, and/or applications with associated hardware. For example, the user device 310 may allow a user to input text for TTS, or otherwise interact with a system which automatically generates text (e.g., a chat agent). In other embodiments, user device 310 may include additional or different modules having specialized hardware and/or software as required. User device 310 may include a speaker allowing for generated speech to be played audibly to a user.

In various embodiments, user device 310 includes other applications as may be desired in particular embodiments to provide features to user device 310. For example, other applications may include security applications for implementing client-side security features, programmatic client applications for interfacing with appropriate application programming interfaces (APIs) over local network 360, or other types of applications. Other applications may also include communication applications, such as email, texting, voice, social networking, and IM applications that allow a user to send and receive emails, calls, texts, and other notifications through local network 360.

Local network 360 may be a network which is internal to an organization, such that information may be contained within secure boundaries. In some embodiments, local network 360 may be a wide area network such as the internet. In some embodiments, local network 360 may be comprised of direct connections between the devices. In some embodiments, local network 360 may represent communication between different portions of a single device (e.g., a network bus on a motherboard of a computation device).

Local network 360 may be implemented as a single network or a combination of multiple networks. For example, in various embodiments, local network 360 may include the Internet or one or more intranets, landline networks, wireless networks, and/or other appropriate types of networks. Thus, local network 360 may correspond to small scale communication networks, such as a private or local area network, or a larger scale network, such as a wide area network or the Internet, accessible by the various components of system 300.

User device 310 may further include database 318 stored in a transitory and/or non-transitory memory of user device 310, which may store various applications and data (e.g., model parameters) and be utilized during execution of various modules of user device 310. Database 318 may store text, audio, style preferences, etc. In some embodiments, database 318 may be local to user device 310. However, in other embodiments, database 318 may be external to user device 310 and accessible by user device 310, including cloud storage systems and/or databases that are accessible over local network 360.

User device 310 may include at least one network interface component 317 adapted to communicate with data server 370 and/or model server 340. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data Server 370 may perform some of the functions described herein. For example, data server 370 may store a training dataset including text, audio, style parameters, etc.

Model server 340 may be a server that hosts models such as the pre-trained TTS model, the audio to vector model described in FIGS. 1A-1D. Model server 340 may provide an interface via local network 360 such that user device 310 may perform functions relating to the models as described herein (e.g., generating speech). Model server 340 may communicate outputs of models via local network 360.

The devices described above may be implemented by one or more hardware components, software components, and/or a combination of the hardware components and the software components. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of the processing element. For example, the processing device may include a plurality of processors or include one processor and one controller. Further, another processing configuration such as a parallel processor may be implemented.

The software may include a computer program, a code, an instruction, or a combination of one or more of them, which configure the processing device to be operated as desired or independently or collectively command the processing device. The software and/or data may be interpreted by a processing device or embodied in any tangible machines, components, physical devices, computer storage media, or devices to provide an instruction or data to the processing device. The software may be distributed on a computer system connected through a network to be stored or executed in a distributed manner. The software and data may be stored in one or more computer readable recording media.

The method according to the exemplary embodiment may be implemented as a program instruction which may be executed by various computers to be recorded in a computer readable medium. At this time, the medium may continuously store a computer executable program or temporarily store it to execute or download the program. Further, the medium may be various recording means or storage means to which a single or a plurality of hardware is coupled and the medium is not limited to a medium which is directly connected to any computer system, but may be distributed on the network. Examples of the medium may include magnetic media such as hard disk, floppy disks and magnetic tapes, optical media such as CD-ROMs and DVDs, magneto-optical media such as optical disks, and ROMs, RAMS, and flash memories to be specifically configured to store program instructions. Further, an example of another medium may include a recording medium or a storage medium which is managed by an app store which distributes application, a site and servers which supply or distribute various software, or the like.

Although the exemplary embodiments have been described above by a limited embodiment and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved. It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method of speech generation, comprising:
generating a style vector via a style module based on an input speech signal;
generating an encoded text via an encoder based on an input text;
modifying the encoded text by a plurality of neural network based layers conditioned by the style vector; and
decoding the modified encoded text to provide an output speech audio.

2. The method of claim 1, further comprising:
summing the encoded text with a speaker ID,
wherein the modifying the encoded text is performed using the summed encoded text.

3. The method of claim 1, wherein the plurality of neural network based layers includes at least one of a conditional Low-Rank Adaptation module, or a variance adaptor.

4. The method of claim 1, further comprising playing the output speech audio via a speaker.

5. A smartphone configured to perform the method of claim 1.
